(19) United States
(12) Patent Application Publication
(10) Pub. No.: US 2009/0283581 A1
(43) Pub. Date: Nov. 19, 2009

(54) PACKAGING AND DISPLAY TRAY FORMED FROM INTERLOCKED BLANKS

(75) Inventors: Allen S. Aldridge, South Orange, NJ (US); Paul K. Bowers, Long Valley, NJ (US); Kerri Clark, Morristown, NJ (US); Brian Hawthorne, Jersey City, NJ (US)

Correspondence Address: HOFFMANN & BARON, LLP, 6900 JERICHO TURNPIKE, SYOSSET, NY, 11791, US

(73) Assignee: Cadbury Adams USA LLC, Parsippany, NJ (US)

(21) Appl. No.: 12/465,021

(22) Filed: May 13, 2009

Related U.S. Application Data
(60) Provisional application No. 61/053,070, filed on May 14, 2008.
(60) Provisional application No. 61/116,805, filed on Nov. 21, 2008.

(51) Int. Cl. B65D 5/00; B31B 1/20; B32B 3/02

(52) U.S. Cl. 229/164; 493/56; 428/192

(57) ABSTRACT

The present invention provides a tray for accommodating and dispensing a stacked plurality of consumable product packages and a method for forming the tray. The tray includes a housing having a bottom wall, opposed front and back walls, and opposed side walls extending upwardly from the bottom wall. The housing defines an open upper end. The side walls include an undulating upper extent defined by space apart upwardly opening recesses. The recesses extend below the stacked packages for permitting manual grasping of the individual stacked packages through the side walls.

### CROSS REFERENCE TO RELATED APPLICATIONS

This application claims priority to U.S. Provisional Patent Application No. 61/053,070 filed on May 14, 2008, and U.S. Provisional Patent Application No. 61/116,805 filed on Nov. 21, 2008, the contents of which are incorporated herein by reference in their entirety.

### FIELD OF THE INVENTION

The present invention relates generally to a display tray for supporting a plurality of stacked consumable product packages. More particularly, the present invention relates to a packaging and display tray formed from a plurality of interlocked flat blanks.

### BACKGROUND OF THE INVENTION

Gum and other consumable products are typically packaged and sold in product packages containing a plurality of such products arranged in an array. The individual product packages may be overwrapped with a wrap which provides environmental protection to the product contained therein. A plurality of such packages may then be arranged in a stacked fashion in a tray or other housing for shipping.

In addition to providing a convenient housing for shipping a plurality of such packages, the package itself may also serve as a display and dispensing tray at the point of sale. Trays of this type typically include a bottom wall and an upstanding perimetrical wall formed in a rectangular configuration. The upper end of the tray is typically opened so that the user may reach into the tray and pick out individual product packages. However, as may be appreciated, it is often difficult to reach deeply into the product package due to the upstanding side walls. The consumer's fingers must fit into the tray which is typically sized to closely accommodate the packages contained therein.

Moreover, such dispensing trays are folded from flat blanks cut from a continuous planar stock. Quite often, due to the particular shape of the tray, there is often waste material between adjacent trays. This increases the cost of manufacture of such trays.

It is, therefore, desirable to provide a product display and dispensing tray for accommodating packages of consumable products which allows the consumer to more easily grasp the product contained therein and which can be formed with less waste during the formation process.

### SUMMARY OF THE INVENTION

The present invention provides a tray for accommodating and dispensing one or a plurality of stacked consumable product packages. The tray includes a housing having a bottom wall, opposed front and back walls, and opposed side walls extending upwardly from the bottom wall. The housing defines an open upper end. One or more of the front and back walls and the side walls include an undulating upper extent defined by space apart upwardly opening recesses. The recesses extend below the stacked packages for permitting manual grasping of the individual stacked packages through the one or more of the front and back walls and the side walls.

The present invention further provides a method for forming a tray for accommodating and dispensing a stacked plurality of consumable product packages. The method steps of the present invention include providing a planar member. A plurality of adjacently arranged flat blanks are cut from the planar member. The blanks each have opposed longitudinal edges, each edge including an undulating configuration defining alternating extensions and recesses. The extensions of one blank are formed in the recesses of the adjacent blank. Thereafter, each blank is folded into a tray shaped housing having a bottom wall and opposed open end. The opposed longitudinal edges define side walls of the housing.

The present invention further provides a flat sheet of material for forming product package trays. The sheet includes first and second adjacent tray blanks having opposed longitudinal side walls and opposed transverse end walls. The side walls have an undulating pattern therealong defining alternating recesses and extending portions. The extending portions of the side wall of one tray are formed from the recesses of the side wall of the other tray.

### BRIEF DESCRIPTION OF THE DRAWINGS

FIG. 1 is a perspective showing of a display tray of the present invention supporting a plurality of consumable product packages therein.

FIG. 2 shows an arrangement of a planar member including blanks used to form the tray of FIG. 1.

FIG. 3 shows a further embodiment of an arrangement of a planar member including blanks used to form a tray similar to FIG. 1.

FIG. 4 shows a portion of the blanks of FIG. 3, after the blanks are cut and separated.

FIG. 5 is a side view showing two trays formed from the blanks of FIG. 3 stacked to form a bottom tray and a top cover.

FIG. 6 shows an example of a blank similar to the blank of FIG. 3, except each blank forms a bottom and a cover tray with a common end wall attaching the trays.

FIG. 7 shows a further embodiment of the blanks with square shaped undulations on the side walls.

FIG. 8 shows a further embodiment of the blanks with plateau shaped undulations on the side walls.

FIGS. 9 and 10 show further configurations of the undulations of the side walls of the tray of the present invention.

FIG. 11 shows a further configuration of the tray of the present invention with undulations along one side wall.

### DETAILED DESCRIPTION OF THE PREFERRED EMBODIMENT

The present invention provides a packaging and display tray for accommodating and dispensing a plurality of product packages. In a preferred embodiment, the product packages contained in the tray are gum packages. However, the present invention may be employed with any packaged comestible item. While the preferred embodiment is described for accommodating a plurality of product packages, it is understood that the tray may be used to accommodate a single product package.

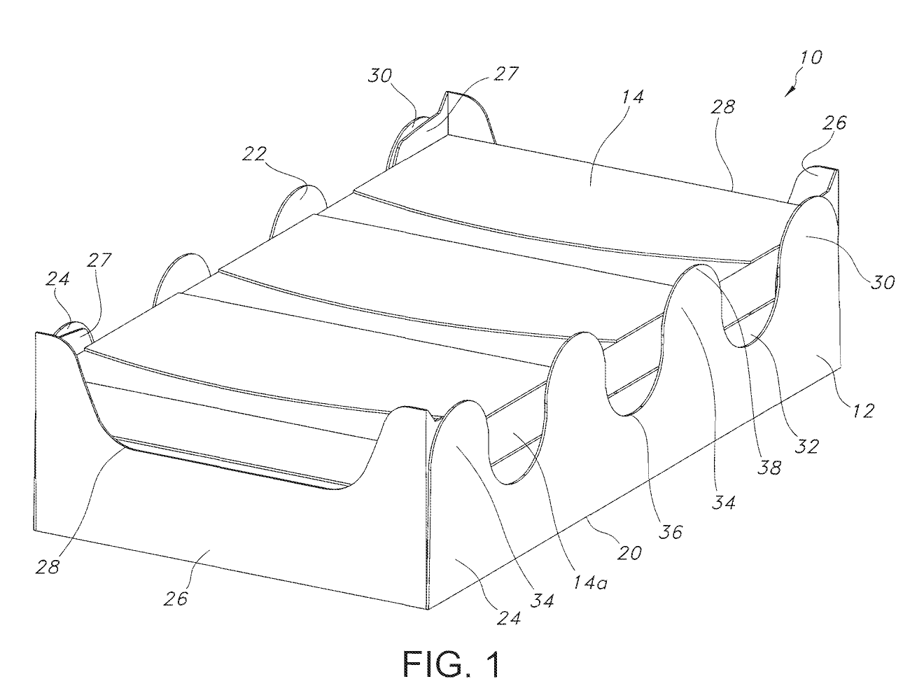

Referring to FIG. 1, a display tray assembly 10 of the present invention is shown. Tray assembly 10 includes a display housing or tray 12 supporting product packages 14. The product packages are preferably packages which support a plurality of comestible products such as gum sticks, slabs, pellets or the like which may be wrapped or unwrapped. Moreover, each individual package 14 may be wrapped with an environmental overwrap (not shown) to environmentally protect the products contained therein.

In the embodiment shown in FIG. 1, where a plurality of stacked packages are shown, nine packages 14 are arranged in a single row stacked three deep. However, as may be appreciated, any number of packages arranged in various orientations may be employed with the present invention by changing the size and shape of the tray 12. The tray 12 includes a planar bottom wall 20 which is opposed to an upper open end 22. The tray 12 is generally rectangular in shape having a pair of opposed longitudinal side walls 24 and opposed transverse end walls 26. It may also be appreciated that other shapes and configurations of the tray may be employed where the dimensions of the side walls and end walls may be changed. Moreover, other geometric shapes are within the contemplation of the present invention.

The end walls 26 define a centrally positioned recessed location 28 which provides front and back access to the packages 14 contained therein and also allows viewing of any advertising or informational indicia contained on the package 14.

The tray 12, preferably with respect to one or more of the side walls 24, includes an undulated upper extent 30 defining alternating recesses 32 and wall portions 34 therebetween. The recesses 32, which may include a rounded bottom 36, extend downwardly from the open upper end 22 a substantial portion of the height of side walls 24. The wall portions 34, having a rounded upper ends 38, extend upwardly and define the boundary of the open upper end 22 of tray 12.

FIG. 1 provides one illustrative embodiment, where each side wall 24 includes three recesses 32 and four extending wall portions 34. However, other numbers and arrangements are also within the contemplation of the present invention. Moreover, while the recesses and extending wall portions are shown to be uniform in FIG. 1, the invention is not limited thereto. The undulating portion may define recesses and extending wall portions of different size and configuration along the length of the side wall. For example, the amplitude and frequency of the undulations need not be uniform along the length of the side wall. In addition, while the undulating portions of both side walls in FIG. 1 are a mirror image of each other, this need not be the case. The undulating portions on each side wall may differ.

The tray 12 is held together in a rectangular configuration by adhesively attaching flange portions 27 adjacent front and back walls 26 to the end wall portions 34 of side walls 24. Other securement techniques may also be employed.

As may be appreciated, when configured as shown in FIG. 1, the recesses 32 of tray 12 provide manual access to the lateral portions 14a of packages 14. In that regard, in one embodiment, it is preferable to have the number of recesses 32 on at least one side wall 24 match the number of stacks of packages 14 where the recesses are positioned generally centrally located with respect to each stack of packages 14. Such an arrangement, for example, allows a user to grasp one package with the thumb and forefinger placed within opposed recess 34 to easily grasp the stacked package. In a preferred embodiment, such as shown in FIG. 1, each recess 32 has a width at a location next adjacent to a package contained therein which is less than the width of the package. This arrangement maintains the package in the tray yet allows manual grasping access thereto. The width of the package is defined to be the extent extending along the undulating side wall of tray 12. The width of the recesses is further defined to be a width between the upstanding portions at a depth of the adjacent package to be removed. In some embodiments, the depth of each recess 32 extends below the upper extent of the lower most stacked package. Such an arrangement also allows manual access to the lower most package while assuring that the packages do not fall out through the recesses.

In order to more efficiently display the packages, the tray 12 is typically formed to closely conform to the stack packages contained therein, which in absence of the features of the present recesses 32 could make it difficult for the user to manually grasp one package from the tray. The recesses 32 formed by the undulating side walls 24 allow the user to grasp the package from the exterior thereof. As will be discussed hereinbelow, the undulating pattern of side walls 24 not only provides for ease of manual access to the packages contained therein, but also provides manufacturing expediency in the formation of the tray 12.

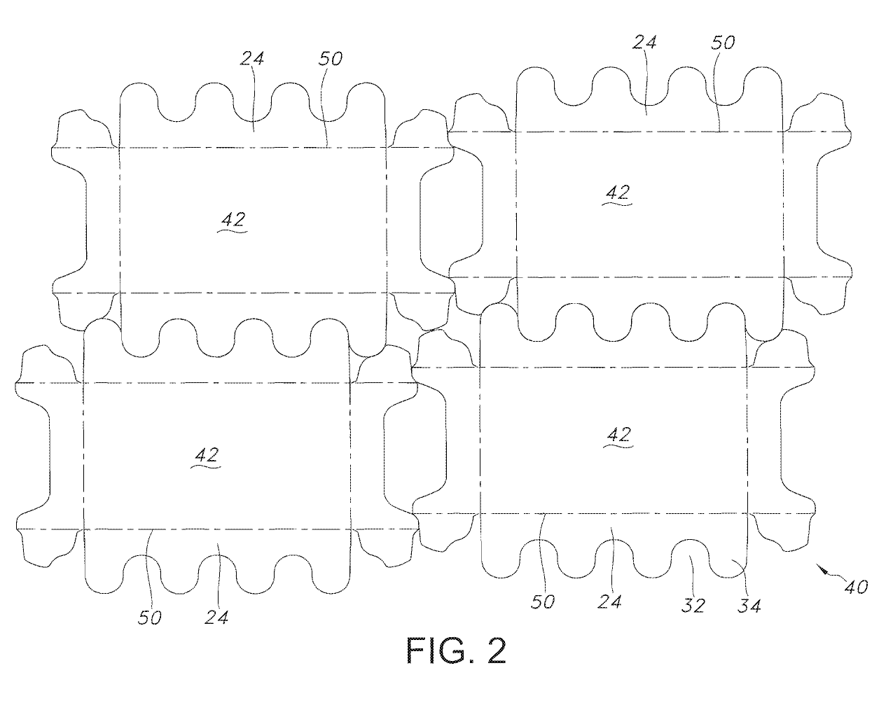

Referring now to FIG. 2, the formation of tray 12 may be described. Tray 12 is formed from a planar member 40 typically formed of corrugated paper or cardboard, which may be laminated or unlaminated, or a variety of other materials well known in the art. The planar member 40 may be cut into a plurality of flat blanks 42 to form a plurality of trays 12. Each blank 42 is then used to form an individual tray 12. While four blanks 42 are shown cut from the planar member 40, it may be appreciated that any number of blanks 42 may be cut from an appropriately sized planar member 40. Furthermore, the blanks 42 may be cut continuously in succession.

Each blank 42 has the general shape shown in FIG. 2 where the undulating side walls 24 extend outwardly in opposite directions. As previously mentioned, the actual shape and size of each undulation on the side walls 24 may be varied, but the blanks 42 are cut such that the wall portions 34 of each side wall are formed from the recesses 32 of a side wall of an adjacent blank 42. Thus, the wall portions 34 and the recesses 32 are interlocked.

For example, the shape of the undulations in the side walls 24 may include, but are not limited to sine waves, square waves, saw waves, and triangular waves. Furthermore, as noted, the size of the undulations may be uniform or irregular in size, provided that the wall portions 34 and the recesses 32 interlock. This significantly reduces waste material, as the material cut from the side wall 24 to form the recesses 32 is not waste material but is material forming the wall portion 34 of the adjacent blank 42.

As used herein throughout, the term “undulation” or “undulating” is understood to mean any configuration formed by extensions and recesses on the wall which has peaks and troughs of any configuration, uniform or non-uniform. Such configurations may include, but not be limited to waves, castillations, zig-zags, crests and valleys. The peaks and troughs may be of various configurations such as round, squares or plateau shaped. A combination of such shapes may be included along a single wall or more walls.

In that regard, side-by-side adjacent blanks 42 are offset slightly so that the longitudinal end wall portion 34 of one blank 42 may be cut from the recesses 32 of the adjacent blank 42. Similar techniques are used to arrange the blank 42 with respect to the end walls 26 and the flange portions 27.

As shown in FIG. 2, the end walls 26 of the longitudinally adjacent blanks 42 are interlocked or nested as are the flange portions 27 with a wall portion 34 of the next adjacent blank 42. This arrangement significantly reduces scrap material generated by the blank 42 formation and, therefore, results in a cost reduction in the manufacture of the tray 12.

Once the blanks 42 are cut from the planar member 40 in a manner shown in FIG. 2, each blank 42 may be folded along fold lines 50 to form the tray 12 shown in FIG. 1. Thereafter, each individual tray 12 may be wrapped with an environmental overwrap (not shown) to additionally protect the contents of package 14.

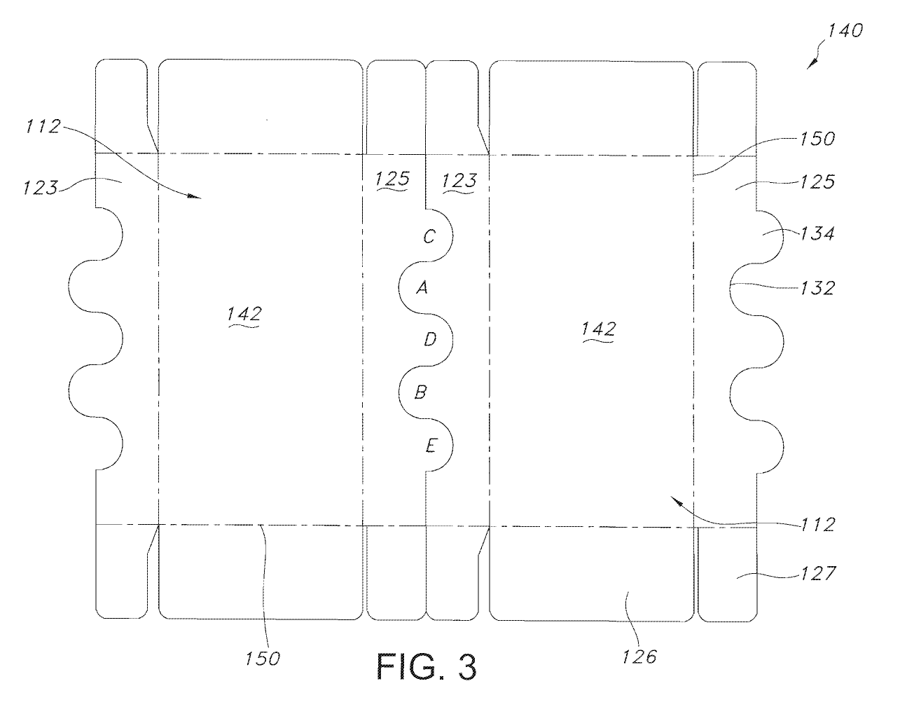

FIGS. 3-5 provide a further preferred embodiment of the tray of the present invention. The tray 112 includes opposing undulating first and second side walls 123, 125. With reference to FIG. 3, the formation of the tray 112 may be described as a variation of the tray 12 described in FIGS. 1-2. The tray 112 is formed from a planar member 140 typically formed of corrugated paper or cardboard, which may be laminated or unlaminated, or a variety of other materials well known in the art. The planar member 140 may be cut into a plurality of flat blanks 142 to form a plurality of trays 112.

Each blank 142 is used to form an individual tray 112. While two blanks 142 are shown cut from a planar member 140, it may be appreciated that any number of blanks 142 may be cut from an appropriately sized planar member. Furthermore, the blanks 142 may be cut continuously in succession.

Each blank 142 has the general shape shown in FIG. 3 where the first and the second side walls 123, 125 extend outwardly in opposite directions. The actual shape and size of each undulation on the side walls 24 may be varied, but the blanks 142 are cut such that the extending wall portions 134 of each side wall are formed from the recesses 132 of a side wall of an adjacent blank 142. Thus, the extending wall portions 134 and the recesses 132 are interlocked.

For example, as in the previous embodiment, the shape of the undulations in the side walls 123, 125 may include, but are not limited to round or sine waves, square waves, saw waves, and triangular waves. Furthermore, the undulations may be uniform or irregular in size, so long as the wall portions 134 and the recesses 132 interlock. This significantly reduces waste material, as the material cut from the first side wall 123 may be used to form the recesses 132 of the second wall 125. Therefore, the material cut to form the extending wall portion 134 of the first side wall 123 is not waste material, but material forming the recesses 132 of the adjacent blank 142 and vice versa.

In that regard, side-by-side adjacent blanks 142 may be configured to be longitudinally aligned so that the longitudinal end wall portion 134 of one blank 142 may be cut from the recess 132 of the adjacent blank 142. Similar techniques are used to arrange the blank 142 with respect to the end walls 126 and the flange portions 127.

As discussed above, the side walls 24 of the tray of FIGS. 1-2 are configured so that there is the same arrangement and number of recesses 32 (three) and extending wall portions 34 (four). In the present embodiment, shown in FIG. 3, the side walls 123, 125 are configured so that there is a different arrangement and number of recesses 132 and extending wall portions 134. In the embodiment shown in FIG. 3, one side wall 123 includes three recesses 132 (C, D, E) and two extending wall portions 134 (A, B), while the other side wall 125 includes two recesses 132 (A, B) and three extending wall portions 134 (C, D, E). Thus, the recesses of one of the side walls are aligned longitudinally with the extending portions of the other side wall and visa versa. The benefit of such an arrangement may be more fully described herein below.

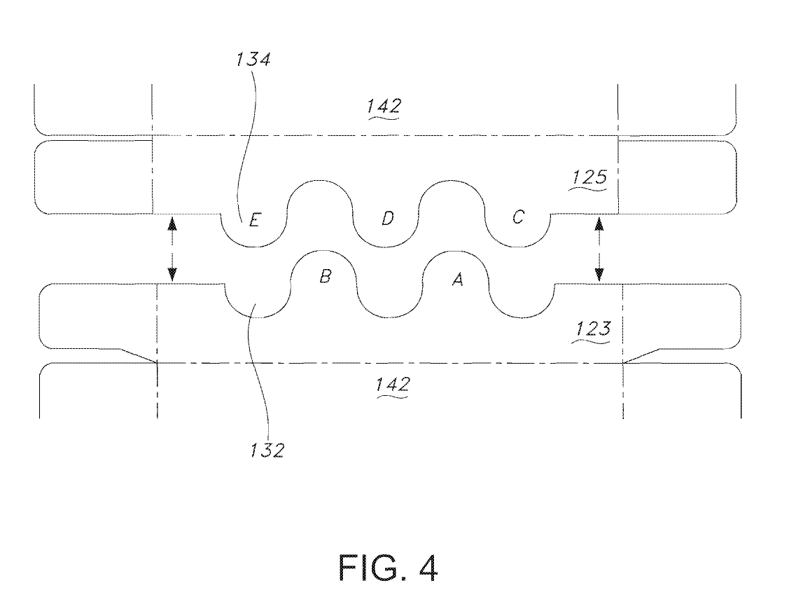

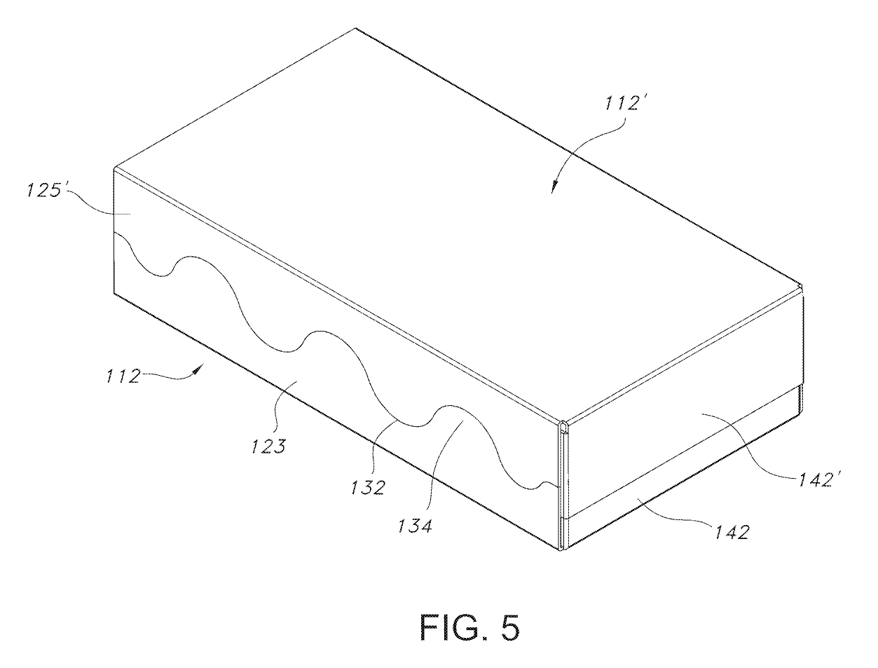

As shown in FIG. 3, the end walls 126 of the adjacent blanks 142 are longitudinally aligned. The flange portion 127 of each blank 142 is also longitudinally aligned with the flange portion 127 of the adjacent blank 142. This arrangement shows each blank 142 having two opposing end walls 126. Two separate blanks 142 maybe folded separately then placed on top of one another to create the cover tray 112′ and the bottom tray 112, as shown in FIGS. 4-5.

The arrangement of FIG. 3 furthers the reduction of scrap material generated by the blank 142 formation, as compared to the blank 42 of FIG. 2, as a result of the alignment of the blanks 142. Therefore, the blanks 142 of FIG. 3 may further reduce the cost of manufacturing the tray 112.

FIG. 4 shows a partial view of two blanks 142 after being cut and separated. FIG. 4 shows the tray 112 with the first side wall 123 with two extending wall portions 134 (A, B) and three recess portions 132 (C, D, E) and the second side wall 125, on the opposite side of the tray, with three extending wall portions 134 (C, D, E) and two recess portions 132 (A, B). FIG. 4 further illustrates how the embodiment may allow the adjacent blank 142 configuration to be longitudinally aligned instead of being longitudinally offset as illustrated in FIG. 2. As noted, this arrangement further reduces the scrap material generated by the blank 142 formation.

The interlocked arrangement of the side walls 123, 125 also provide a further beneficial feature, shown in FIG. 5. Two identically folded trays 112 may serve as the base or bottom tray 112 and an interlocked top cover or top tray 112′. The blanks 142 are cut from the planar member 140 in a manner shown in FIG. 3, the cut blanks 142 may be folded along fold lines 150 to form the trays 112. One blank 142 may serve as a bottom tray 112, while the other blank 142′ may be inverted and serve as a cover tray 112′. The trays 112 and 112′ may be arranged such that the side wall 125′ of the cover tray 112′ is aligned with side wall 123 of bottom tray 112. As may be applied, the opposite side walls (not shown) are similarly disposed. This arrangement allows the undulated side walls to be interlocked or nested within the opposing undulated first and second side walls 123′, 125, 123, 125′.

The design of the present embodiment of the invention allows for the manufacture of one blank 142 to be used as both a bottom tray 112 and a cover tray 112′. Thus, the present invention allows for the product to be displayed, packaged, and shipped using the one tray 112 provided in FIGS. 3-5 herein.

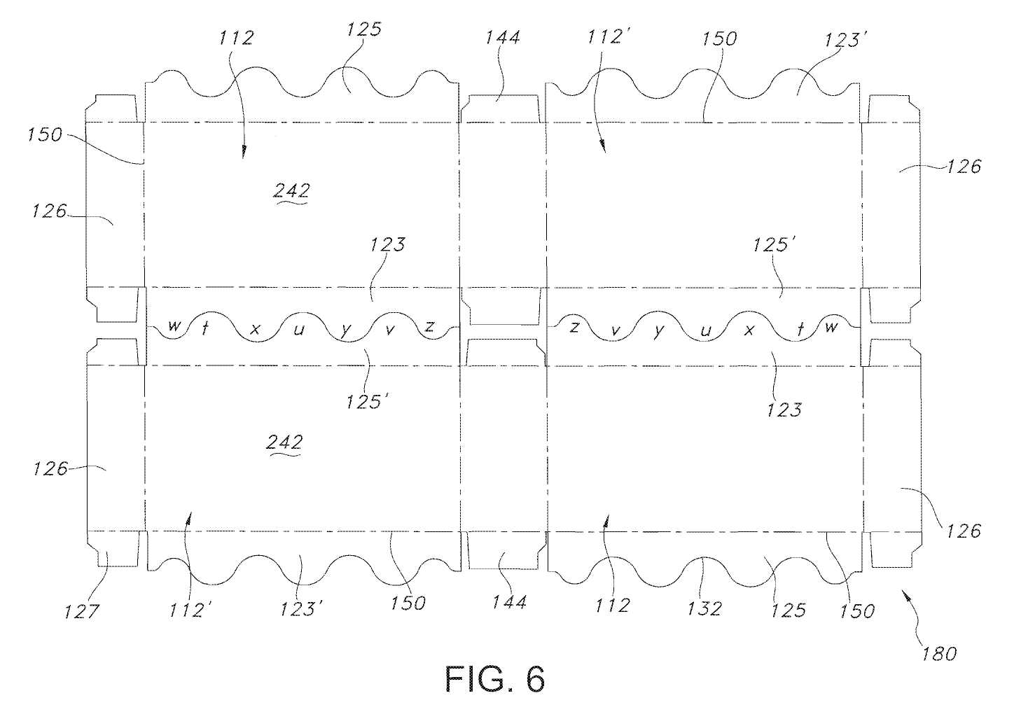

FIG. 6 provides an example of a blank 242 similar to the blank 142 of FIG. 3, except each blank 242 forms two trays 112, 112′, with each tray 112, 112′ having one separate end wall 126 and a common end wall 144. The blanks 242 are configured to allow one-half of the blank 242 to be folded to create a cover tray 112′ and the other half of the blank 242 to be folded to create a bottom tray 112.

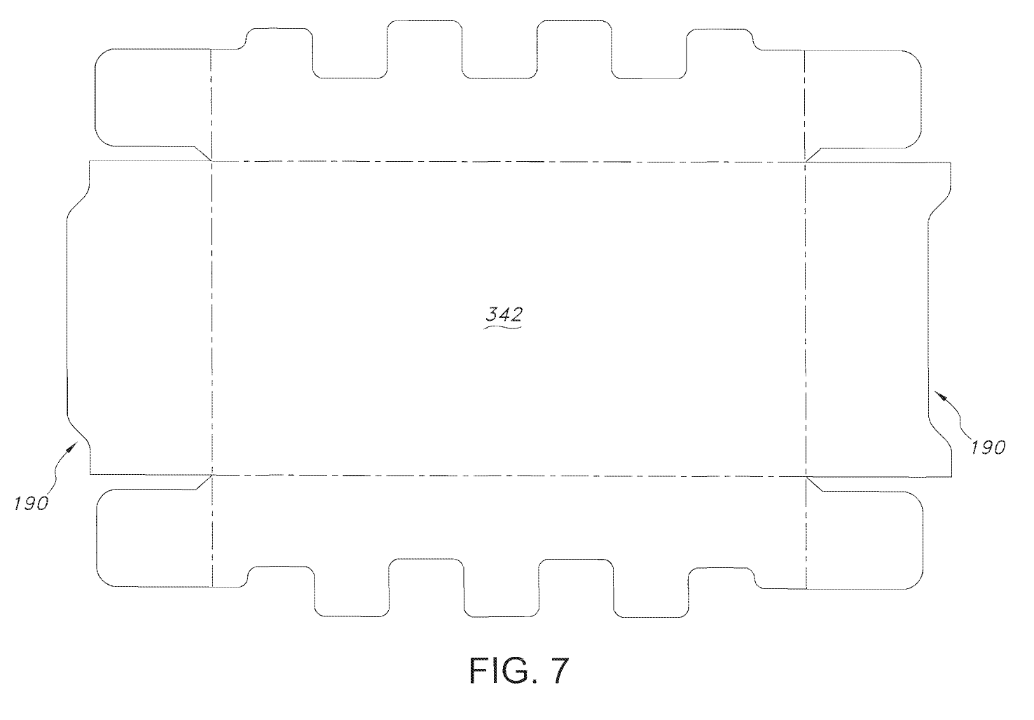

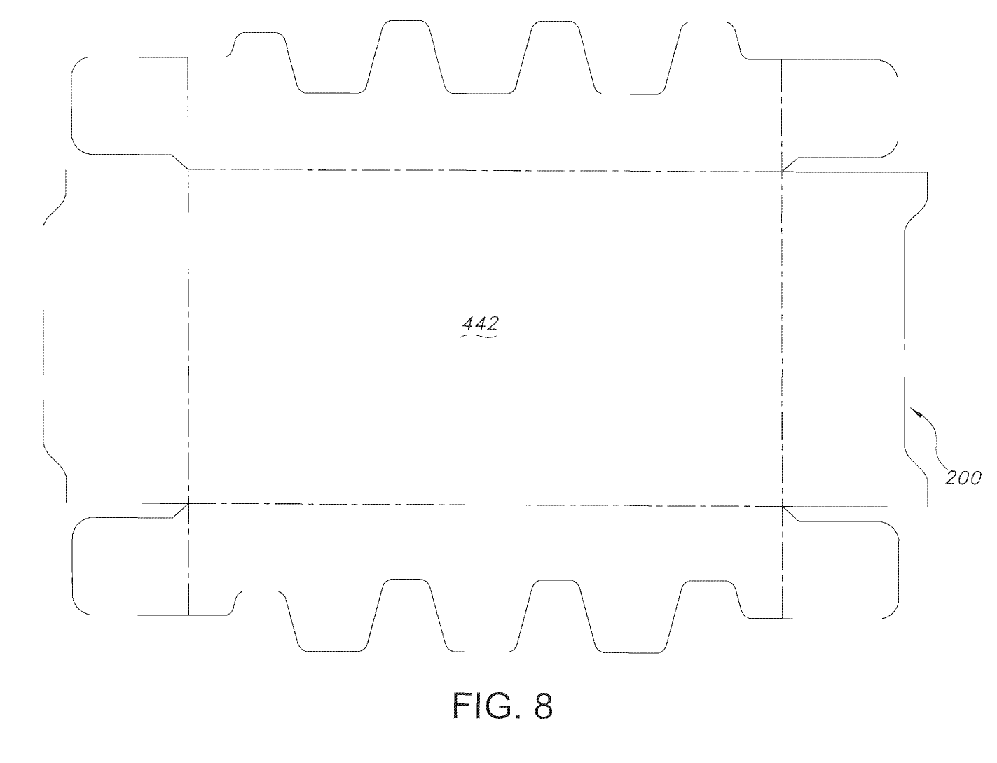

Other configurations of the blanks further contemplated include, but are not limited to varying the size and shape of the undulating areas, such as square undulations, triangle undulations, and plateaus on the edge of undulations. Moreover, the size of the undulations may be varied or irregular so that the undulations on the end of the sides are smaller than in the center undulations and vice versa. FIGS. 7-8 provide examples of other blank configurations.

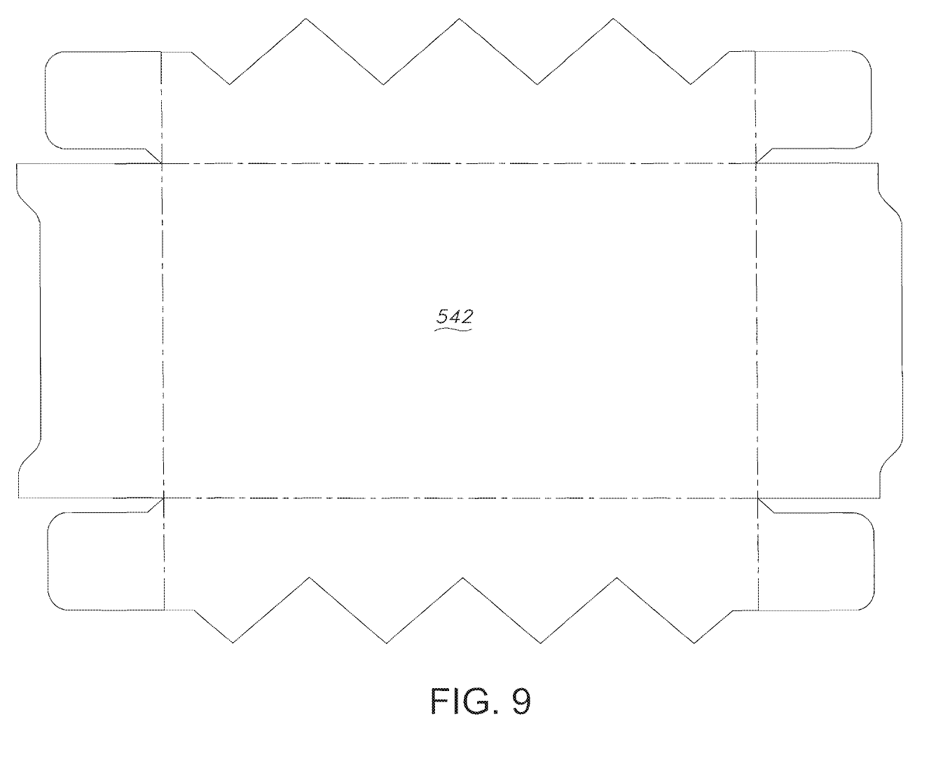

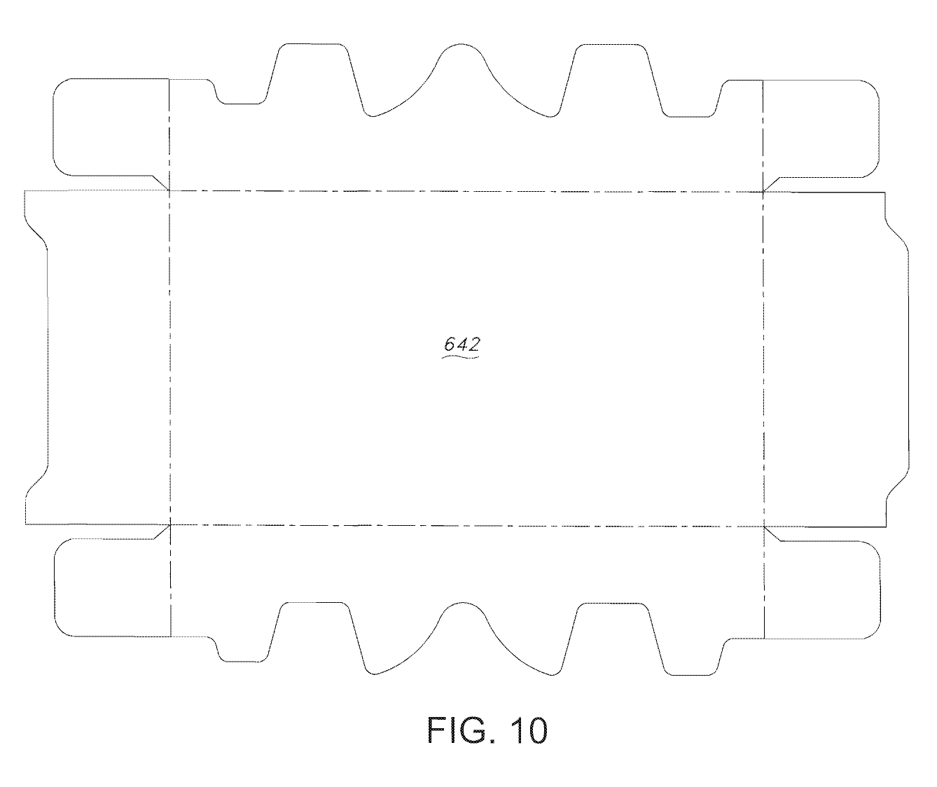

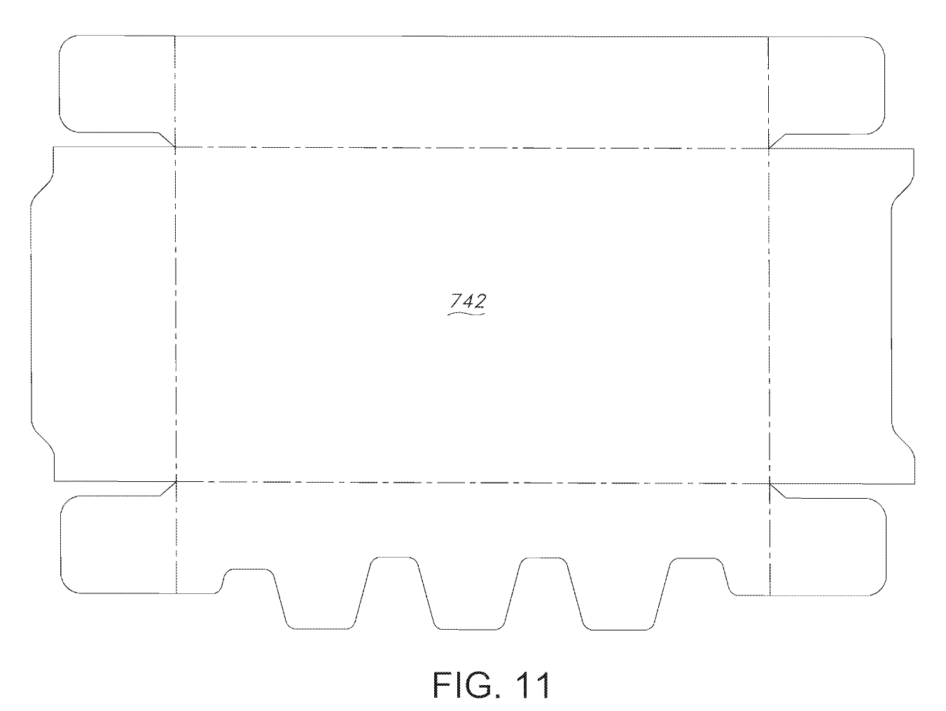

Specifically, FIG. 7 shows a blank 342 with square undulations. FIG. 8 shows a blank 442 with plateaus on the edge of the undulations. FIG. 9 shows a blank 547 with a zig-zag pattern of undulations along the side walls. FIG. 10 shows a blank 647 having side walls with a non-uniform pattern of undulations therealong. FIG. 11 shows a blank 747 having only one side wall including undulations therealong. The opposed side wall has no undulations. The undulations of the side wall of FIG. 11 may be of any configuration, both uniform and non-uniform.

### Items

Item 1. A tray for accommodating and dispensing a stacked plurality of comestible product packages comprising:

a housing having a bottom wall, opposed front and back walls and opposed side walls extending upwardly from said bottom wall and defining an open upper end;

where at least one of said opposed front, back or said side walls include an undulating upper extent defined by spaced apart upwardly opening recesses, said recesses having an open portion extending below the stacked package for permitting manual grasping of individual stacked packages through said at least one of said opposed front and back walls and said side walls.

Item 2. A tray of item 1 wherein said side walls include said undulating upper extent and said recesses.

Item 3. A tray of item 2 wherein said side walls include a first side wall and a second side wall.

Item 4. A tray of item 3 wherein said first side wall contains a first number of recesses and said second side wall contains a second number of recesses.

Item 5. A tray of item 4 wherein said first number of recesses is the same as said second number of recesses.

Item 6. A tray of item 4 wherein said first number of recesses is different than said second number of recesses.

Item 7. A tray of item 6 wherein said recesses of said first side wall directly oppose said upwardly extending wall portions of said second side wall.

Item 8. A tray of items 1-7 wherein said recesses have a round bottom.

Item 9. A tray of items 1-7 wherein said recesses have a square bottom.

Item 10. A tray of items 1-7 wherein said recesses have a plateau shaped bottom.

Item 11. A tray of items 1-7 wherein said undulating upper extent defines an upwardly extending wall portion between each said recess.

Item 12. A tray of item 11 wherein said upwardly extending wall portions are rounded.

Item 13. A tray of item 11 wherein said upwardly extending wall portions are square shaped.

Item 14. A tray of item 11 wherein said upwardly extending wall portions are plateau shaped.

Item 15. A tray of item 11 wherein said upwardly extending wall portions are zig-zag shaped.

Item 16. A method of forming a tray for accommodating and dispensing a stacked plurality of consumable product packages comprising the steps of:

providing a planar member;

cutting a plurality of adjacently arranged flat blanks from said planar member, said blanks each having opposed longitudinal edges each having an undulating configuration defining alternating extensions and recesses, said extensions of one said blank being formed in the recesses of the adjacent said blank; and

folding each said blank into a tray-shaped housing having a bottom wall and an opposed open end, wherein said opposed longitudinal edges define side walls of said housing.

Item 17. A method of item 16 wherein said cutting step further includes continuously cutting a plurality of said blanks in succession.

Item 18. A method of item 16 wherein said cutting step further includes cutting a first side wall such that said first side wall contains a first number of said recesses.

Item 19. A method of item 18 wherein said cutting step further includes cutting a second side wall such that said second side wall contains a second number of said recesses, wherein said first number of said recesses is the same as said second number of said recesses.

Item 20. A method of item 18 wherein said cutting step further includes cutting a second side wall such that said second side wall contains a second number of said recesses, wherein said second number of said recesses is different than said first number of said recesses.

Item 21. A method of items 16-20 wherein said folding step includes folding said housing to form opposed end walls.

Item 22. A method of items 16-20 further comprising placing a tray on top of another tray to create a cover, wherein each said first side wall and each said second side wall are configured such that each said recess of said first side wall fits into each said extension of said second side wall.

Item 23. A method of item 22, wherein two adjacent blanks are configured to be foldably connected by a common wall, said common wall replaces one of said end walls on each of said two adjacent blanks.

Item 24. A method of item 23, wherein said cutting step further including cutting said two adjacent blanks, said common wall holding said two adjacent blanks together.

Item 25. A method of item 24 wherein said folding steps further include folding said two adjacent blanks to form two attached trays with a cover tray and a bottom tray connected by said common end wall.

Item 26. A method of items 16-20 wherein said flat blanks are arranged such that said undulations on the opposing side walls are nested and longitudinally aligned.

Item 27. A method of items 16-20 wherein said flat blanks are arranged such that said undulations on the opposing side walls are nested and longitudinally offset.

Item 28. A tray assembly comprising:

a first tray configured to be a bottom tray; and

a second tray configured to be a cover tray, said first said second trays being identically configured;

said first tray and said second tray each including a bottom wall, opposed front and back walls, and opposed side walls extending upwardly from said bottom wall and defining an upper open end, said opposed side walls further including an undulating configuration defining alternating extensions and recesses on said opposed side walls,

wherein said first tray and said second tray are longitudinally nested and aligned such that said second tray is configured to fit on top of said first tray with said extensions of said first tray aligned and nested with said recesses of said second tray and said recesses of said first tray aligned and nested with said extensions of said second tray.

Item 29. A tray of item 28 wherein said side walls include a first side wall and a second side wall.

Item 30. A tray of item 29 wherein said first side wall contains a first number of recesses and said second side wall contains a second number of recesses.

Item 31. A tray of item 30 wherein said first number of recesses is the same as said second number of recesses.

Item 32. A tray of item 30 wherein said first number of recesses is different than said second number of recesses.

Item 33. A tray of item 32 wherein said recesses of said first side wall directly oppose said upwardly extending wall portions of said second side wall.

Item 34. In combination, a tray and at least one comestible product package, said combination comprising:

a tray housing for accommodating said product package, said tray housing having a bottom wall, a pair of opposed longitudinal side walls and opposed transverse end walls defining a housing perimeter upstanding from said bottom wall;

at least one of said side walls including an undulating pattern of recesses and wall portions extending the length of the side wall, said recesses permitting manual access to said package through said side walls.

Item 35. The combination of item 34 wherein said product package has an upper extent and said recesses extend below said upper extent of said product package supported in said tray housing.

Item 36. The combination of items 34-35 wherein said product package is supported adjacent one said recess and wherein said recess has a width adjacent said product package which is less than the width of said product package supported in said tray housing.

Item 37. The combination of items 34-36 which said undulating pattern is uniform along said side walls.

Item 38. The combination of items 34-36 wherein said undulating portion of each of said side wall is such that the recesses of one side wall are longitudinally aligned with the wall portions of the other side wall.

Item 39. The combination of items 34-36 wherein said undulating pattern of each side wall is such that the recesses of one side wall are longitudinally aligned with the recesses of the other side wall.

Item 40. The combination of item 38 further including a pair of said tray housings wherein one said tray housing of said pair is nestable with the other said tray housing of said pair and wherein the wall portions of said one tray housing fit into the recesses of the other tray housing.

Item 41. The combination of items 34-36 wherein said tray housing is formed from a flat blank.

Item 42. The combination of item 41 wherein said pair of said tray housings are formed from adjacent nested flat blanks wherein the wall portions of one of said tray housing is formed from the recesses of said other tray housing.

Item 43. A flat sheet of material for forming a plurality of packaging trays comprising:

a first tray blank formed in said sheet, said first blank having a generally rectangular configuration including opposed longitudinal side walls and opposed transverse end walls, said side walls having an undulating pattern therealong defining alternating recesses and extending portions;

a second tray blank formed in said sheet, said second blank having a generally rectangular configuration including opposed longitudinal side walls and opposed transverse end walls, said side walls having an undulating pattern therealong defining alternating recesses and extending portions;

wherein first and second flat blanks are adjacently positioned and said extending portions of the side wall of said first tray are formed from the recesses of the side wall of the said second tray.

Item 44. A flat sheet of item 43 wherein each of said side walls of each of said first and second tray blanks have the same number of recesses and extending portions therealong and wherein said adjacent first and second tray blanks are longitudinally staggered.

Item 45. A flat sheet of item 43 wherein each of said side walls of each of said first and second tray blanks have a different number of recesses and extending portions therealong and wherein said adjacent first and second tray blanks are longitudinally aligned.

Item 46. A flat sheet of item 45 wherein one of said first and second tray blanks is constructed to define a tray housing for accommodating at least one comestible product package therein.

Item 47. A flat sheet of claim 46 wherein the other of said first and second tray blanks is constricted to define a tray cover for overlying nesting engagement with said one tray housing.

Various changes to the foregoing described and shown structures would now be evident to those skilled in the art. Accordingly, the particularly disclosed scope of the invention is set forth in the following claims.

What is claimed:

1. A tray for accommodating and dispensing a stacked plurality of comestible product packages comprising:
a housing having a bottom wall, opposed front and back walls and opposed side walls extending upwardly from said bottom wall and defining an open upper end;
where at least one of said opposed front, back or said side walls include an undulating upper extent defined by spaced apart upwardly opening recesses, said recesses having an open portion extending below the stacked package for permitting manual grasping of individual stacked packages through said at least one of said opposed front and back walls and said side walls.

2. A tray of claim 1 wherein said side walls include said undulating upper extent and said recesses.

3. A tray of claim 2 wherein said side walls include a first side wall and a second side wall.

4. A tray of claim 3 wherein said first side wall contains a first number of recesses and said second side wall contains a second number of recesses.

5. A tray of claim 4 wherein said first number of recesses is the same as said second number of recesses.

6. A tray of claim 4 wherein said first number of recesses is different than said second number of recesses.

7. A tray of claim 6 wherein said recesses of said first side wall directly oppose said upwardly extending wall portions of said second side wall.

8. A tray of claim 1 wherein said recesses have a round bottom.

9. A tray of claim 1 wherein said recesses have a square bottom.

10. A tray of claim 1 wherein said recesses have a plateau shaped bottom.

11. A tray of claim 1 wherein said undulating upper extent defines an upwardly extending wall portion between each said recess.

12. A tray of claim 11 wherein said upwardly extending wall portions are rounded.

13. A tray of claim 11 wherein said upwardly extending wall portions are square shaped.

14. A tray of claim 11 wherein said upwardly extending wall portions are plateau shaped.

15. A tray of claim 11 wherein said upwardly extending wall portions are zig-zag shaped.

16. A method of forming a tray for accommodating and dispensing a stacked plurality of consumable product packages comprising the steps of:
providing a planar member;
cutting a plurality of adjacently arranged flat blanks from said planar member, said blanks each having opposed longitudinal edges each having an undulating configuration defining alternating extensions and recesses, said extensions of one said blank being formed in the recesses of the adjacent said blank; and
folding each said blank into a tray-shaped housing having a bottom wall and an opposed open end, wherein said opposed longitudinal edges define side walls of said housing.

17. A method of claim 16 wherein said cutting step further includes continuously cutting a plurality of said blanks in succession.

18. A method of claim 16 wherein said cutting step further includes cutting a first side wall such that said first side wall contains a first number of said recesses.

19. A method of claim 18 wherein said cutting step further includes cutting a second side wall such that said second side wall contains a second number of said recesses, wherein said first number of said recesses is the same as said second number of said recesses.

20. A method of claim 18 wherein said cutting step further includes cutting a second side wall such that said second side wall contains a second number of said recesses, wherein said second number of said recesses is different than said first number of said recesses.

21. A method of claim 16 wherein said folding step includes folding said housing to form opposed end walls.

22. A method of claim 19 further comprising placing a tray on top of another tray to create a cover, wherein each said first side wall and each said second side wall are configured such that each said recess of said first side wall fits into each said extension of said second side wall.

23. A method of claim 22, wherein two adjacent blanks are configured to be foldably connected by a common wall, said common wall replaces one of said end walls on each of said two adjacent blanks.

24. A method of claim 23, wherein said cutting step further including cutting said two adjacent blanks, said common wall holding said two adjacent blanks together.

25. A method of claim 24 wherein said folding steps further include folding said two adjacent blanks to form two attached trays with a cover tray and a bottom tray connected by said common end wall.

26. A method of claim 16 wherein said flat blanks are arranged such that said undulations on the opposing side walls are nested and longitudinally aligned.

27. A method of claim 16 wherein said flat blanks are arranged such that said undulations on the opposing side walls are nested and longitudinally offset.

28. A tray assembly comprising:
a first tray configured to be a bottom tray; and
a second tray configured to be a cover tray, said first said second trays being identically configured;
said first tray and said second tray each including a bottom wall, opposed front and back walls, and opposed side walls extending upwardly from said bottom wall and defining an upper open end, said opposed side walls further including an undulating configuration defining alternating extensions and recesses on said opposed side walls,
wherein said first tray and said second tray are longitudinally nested and aligned such that said second tray is configured to fit on top of said first tray with said extensions of said first tray aligned and nested with said recesses of said second tray and said recesses of said first tray aligned and nested with said extensions of said second tray.

29. A tray of claim 28 wherein said side walls include a first side wall and a second side wall.

30. A tray of claim 29 wherein said first side wall contains a first number of recesses and said second side wall contains a second number of recesses.

31. A tray of claim 30 wherein said first number of recesses is the same as said second number of recesses.

32. A tray of claim 30 wherein said first number of recesses is different than said second number of recesses.

33. A tray of claim 32 wherein said recesses of said first side wall directly oppose said upwardly extending wall portions of said second side wall.

34. In combination, a tray and at least one comestible product package, said combination comprising:
a tray housing for accommodating said product package, said tray housing having a bottom wall, a pair of opposed longitudinal side walls and opposed transverse end walls defining a housing perimeter upstanding from said bottom wall;
at least one of said side walls including an undulating pattern of recesses and wall portions extending the length of the side wall, said recesses permitting manual access to said package through said side walls.

35. The combination of claim 34 wherein said product package has an upper extent and said recesses extend below said upper extent of said product package supported in said tray housing.

36. The combination of claim 34 wherein said product package is supported adjacent one said recess and wherein said recess has a width adjacent said product package which is less than the width of said product package supported in said tray housing.

37. The combination of claim 34 which said undulating pattern is uniform along said side walls.

38. The combination of claim 34 wherein said undulating portion of each of said side wall is such that the recesses of one side wall are longitudinally aligned with the wall portions of the other side wall.

39. The combination of claim 34 wherein said undulating pattern of each side wall is such that the recesses of one side wall are longitudinally aligned with the recesses of the other side wall.

40. The combination of claim 38 further including a pair of said tray housings wherein one said tray housing of said pair is nestable with the other said tray housing of said pair and wherein the wall portions of said one tray housing fit into the recesses of the other tray housing.

41. The combination of claim 34 wherein said tray housing is formed from a flat blank.

42. The combination of claim 41 wherein said pair of said tray housings are formed from adjacent nested flat blanks wherein the wall portions of one of said tray housing is formed from the recesses of said other tray housing.

43. A flat sheet of material for forming a plurality of packaging trays comprising:
a first tray blank formed in said sheet, said first blank having a generally rectangular configuration including opposed longitudinal side walls and opposed transverse end walls, said side walls having an undulating pattern therealong defining alternating recesses and extending portions;
a second tray blank formed in said sheet, said second blank having a generally rectangular configuration including opposed longitudinal side walls and opposed transverse end walls, said side walls having an undulating pattern therealong defining alternating recesses and extending portions;
wherein first and second flat blanks are adjacently positioned and said extending portions of the side wall of said first tray are formed from the recesses of the side wall of the said second tray.

44. A flat sheet of claim 43 wherein each of said side walls of each of said first and second tray blanks have the same number of recesses and extending portions therealong and wherein said adjacent first and second tray blanks are longitudinally staggered.

45. A flat sheet of claim 43 wherein each of said side walls of each of said first and second tray blanks have a different number of recesses and extending portions therealong and wherein said adjacent first and second tray blanks are longitudinally aligned.

46. A flat sheet of claim 45 wherein one of said first and second tray blanks is constructed to define a tray housing for accommodating at least one comestible product package therein.

47. A flat sheet of claim 46 wherein the other of said first and second tray blanks is constructed to define a tray cover for overlying nesting engagement with said one tray housing.
